(19) United States
(12) Patent Application Publication
(10) Pub. No.: US 2017/0087811 A1
(43) Pub. Date: Mar. 30, 2017

(54) SCREENMEND

(71) Applicant: SCREEN MEND LLC, Chicago, IL (US)

(72) Inventors: Chris Quinn, Highland, UT (US); Reed Quinn, Highland, UT (US)

(73) Assignee: SCREEN MEND LLC, Chicago, IL (US)

(21) Appl. No.: 14/865,357

(22) Filed: Sep. 25, 2015

(51) Int. Cl. B32B 27/12; B32B 27/30; E06B 9/52; B32B 5/02

(52) U.S. Cl. CPC B32B 27/12; B32B 5/028; B32B 27/306; E06B 9/52; B32B 2405/00; B32B 2556/00; B32B 2255/26; B32B 2255/06; E06B 2009/524

(57) ABSTRACT

A screen repair system. The screen repair system includes a screen mesh. The screen repair system also includes a laminate, wherein the laminate is located on the screen mesh and configured to secure the screen mesh to an existing screen.

### CROSS-REFERENCE TO RELATED APPLICATIONS

Not applicable.

### BACKGROUND OF THE INVENTION

Screens serve an important function. In particular, the allow air and light to pass while blocking insects, leaves and other debris. Typically, screens appear in many places, especially in homes. For example, a window screen, also known as insect screen or bug screen is designed to cover the opening of a window. The mesh is usually made of metal wire, fiberglass, or other synthetic fiber and stretched in a frame of wood or metal. It serves to keep leaves, debris, insects, birds, and other animals from entering a building or a screened structure such as a porch, without blocking fresh air-flow.

A screen door can refer to a hinged storm door (cold climates) or hinged screen door (warm climates) covering an exterior door; or a screened sliding door used with sliding glass doors. In any case, the screen door incorporates screen mesh to block flying insects or cottonwood seeds from entering and pets and small children from exiting interior spaces, while allowing for air, light, and views.

A screened porch is a type of porch or similar structure on or near the exterior of a house that has been covered by window screens in order to hinder insects, debris, and other undesirable objects from entering the area inside the screen. Typically created to enhance the liveability of a structure that would otherwise be exposed to the annoyances of the outdoors, screened porches often permit residents to enjoy an indoor environment outdoors.

When these screens suffer damage to the screen mesh repair may be a large project. Typically the screen mesh must be removed around the edges of the frame. The screen mesh is then discarded and new mesh is added, attaching the screen mesh along the frame.

Accordingly, there is a need in the art for a system that allows a user to repair a screen rather than replace the screen. Further, there is a need for the system to work with the existing screen.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a screen repair system. The screen repair system includes a screen mesh. The screen repair system also includes a laminate, wherein the laminate is located on the screen mesh and configured to secure the screen mesh to an existing screen.

Another example embodiment includes a screen repair system. The screen repair system includes a screen mesh, wherein the screen mesh includes fiberglass strands. The screen repair system also includes a PVC dip coating on the screen mesh. The screen repair system further includes a laminate. The laminate includes EVA hot melt glue and is configured to melt between 90° C. and 100° C. The laminate is located on the screen mesh and configured to secure the screen mesh to an existing screen.

Another example embodiment includes a method for repairing an existing screen. The method includes providing a screen repair system. The screen repair system includes a screen mesh. The screen repair system also includes a PVC dip coating on the screen mesh. The screen repair system further includes a laminate. The laminate includes EVA hot melt glue. The laminate is located on the screen mesh and configured to secure the screen mesh to an existing screen. The method also includes cutting the screen mesh to the desired size and heating the laminate. The method also includes placing the cut patch over a damaged section of the existing screen and allowing the laminate to cool.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a front view of an example of a screen repair system;

FIG. 1B illustrates a side view of an example of a screen repair system;

FIG. 2 illustrates an example of a screen repair using the screen repair system;

FIG. 3 is a flow chart illustrating a method of repairing an existing screen using a screen repair system; and

FIG. 4 is a flow chart illustrating a method 400 of repairing an existing screen using a screen repair system that utilizes a spry adhesive.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

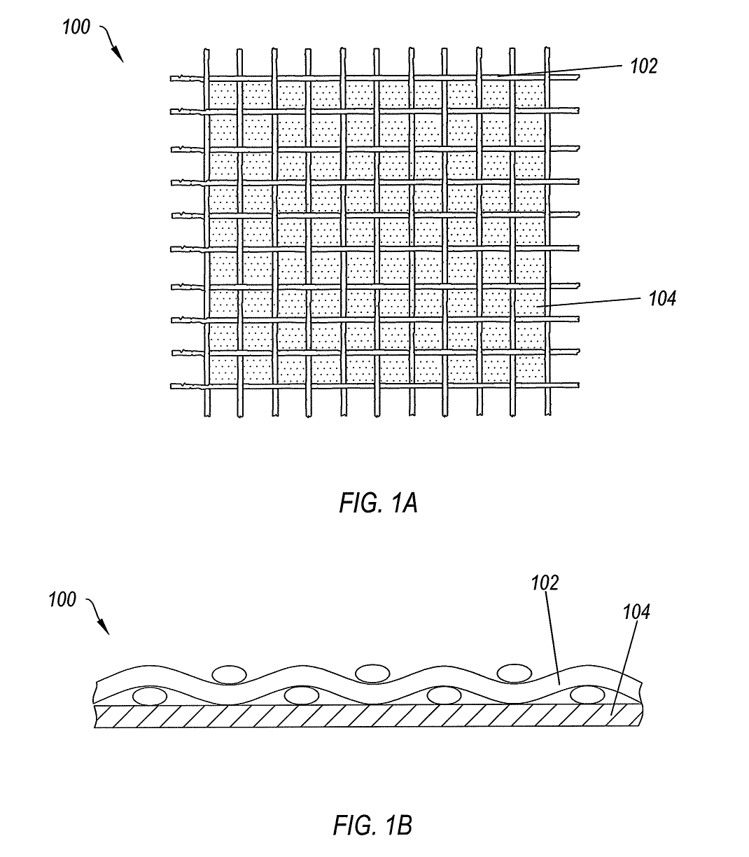

FIGS. 1A and 1B (collectively “FIG. 1”) illustrate an example of a screen repair system 100. FIG. 1A illustrates a front view of an example of a screen repair system; and FIG. 1B illustrates a side view of an example of a screen repair system. The screen repair system 100 can be used to repair a tear or hole in a screen. In particular, the screen repair system 100 bonds a new portion of screen mesh to an existing screen. The repair allows the screen to perform its desired function, allowing air to pass through an opening such as a window or door while preventing the entry of insects or debris.

FIG. 1 shows that the screen repair system 100 can include a screen mesh 102. The screen mesh 102 is a barrier made of connected strands of metal, fiber, or other flexible/ductile materials. A mesh is similar to a web or a net in that it has many attached or woven strands. The screen mesh 102 serves to keep leaves, debris, insects, birds, and other animals from entering a building or a screened structure such as a porch, without blocking fresh air-flow. The screen mesh can be made from any desired material. For example, the screen mesh 102 can include aluminum or fiberglass. Fiberglass is less expensive, and has the advantage of not “denting” when hit or pushed, but it is somewhat more opaque than aluminum. For applications requiring greater strength, such as screened doors, nylon and polyester screening are also available. The size of the screen mesh 102 can be critical to match the screen mesh 102 to existing screen materials. For example, the mesh can weigh approximately 110 g per square meter and can have a fiberglass filament diameter of approximately 0.25 mm.

The screen mesh 102 can include one or more coatings on the strands. For example, the screen mesh 102 can be PVC dipped. Polyvinyl chloride, more correctly but unusually poly (vinyl chloride), commonly abbreviated PVC protects the strands and prevents them from irritating a user. For example, if the strands are fiberglass the PVC coating prevents the strands from fraying which both weakens the screen mesh 102 and irritates the skin of a user when touched.

FIG. 1 also shows that the screen repair system 100 can include a laminate 104. The laminate 104 is configured to secure the screen mesh 102 to an existing screen material. In particular, the laminate 104 forms a permanent attachment to the existing screen material. For example, the laminate can include Ethylene-vinyl acetate (EVA) hot melt glue. EVA is the copolymer of ethylene and vinyl acetate. The weight percent vinyl acetate usually varies from 10% to 40%, with the remainder being ethylene. It is a polymer that approaches elastomeric materials in softness and flexibility, yet can be processed like other thermoplastics. Hot melt adhesives are non-tacky at room temperature but when heated become very sticky. Once cooled to room temperature they are once again safe to handle and all tackiness is lost. The laminate 104 can be solid or can be webbed. A webbed laminate 104 can improve the look and breathability of the repaired screen. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

Additionally or alternatively, the laminate 104 can be created during the repair using a spray on adhesive. In particular, the adhesive can be sprayed on the screen mesh 102 to adhere the screen mesh 102 to the existing screen material. Spraying the adhesive can ensure that the adhesive “sticks” to the screen mesh, allowing air to pass through the mesh.

The properties of the laminate 104 can be critical to affect the screen repair. For example, the laminate 104 can be configured to melt between 90° C. and 100° C. This allows the laminate to remain stable and unmelted at shipping temperatures (overseas shipping containers may get quite hot—over 60° C.—while on a cargo ship) but still allow a user to melt the laminate 104 with a hair dryer or other home appliance. Likewise, the melt temperature should be well above normal day time temperatures or the efficacy of the repair may be compromised.

Likewise, the ratio of screen mesh 102 to laminate 104 can be critical to retain the desired properties of the repaired screen. For example, too much laminate 104 can clog the holes within the mesh and eliminate air flow while too little laminate 104 can create a weak repair. Therefore, the screen mesh 102 can be approximately 46% (e.g., approximately 30% fiberglass net and approximately 16% PVC dip coating) of the screen repair system 100 by weight and the laminate can be approximately 54% of the screen repair system 100 by weight. Additionally or alternatively, the thickness of the laminate 104 can be configured to allow for proper screen repair. For example, the thickness of the laminate 104 can be approximately 0.4 mm, which is sufficient to secure the repair without restricting air flow. As used in the specification and the claims, the term approximately shall mean that the value is within 10% of the stated value, unless otherwise specified.

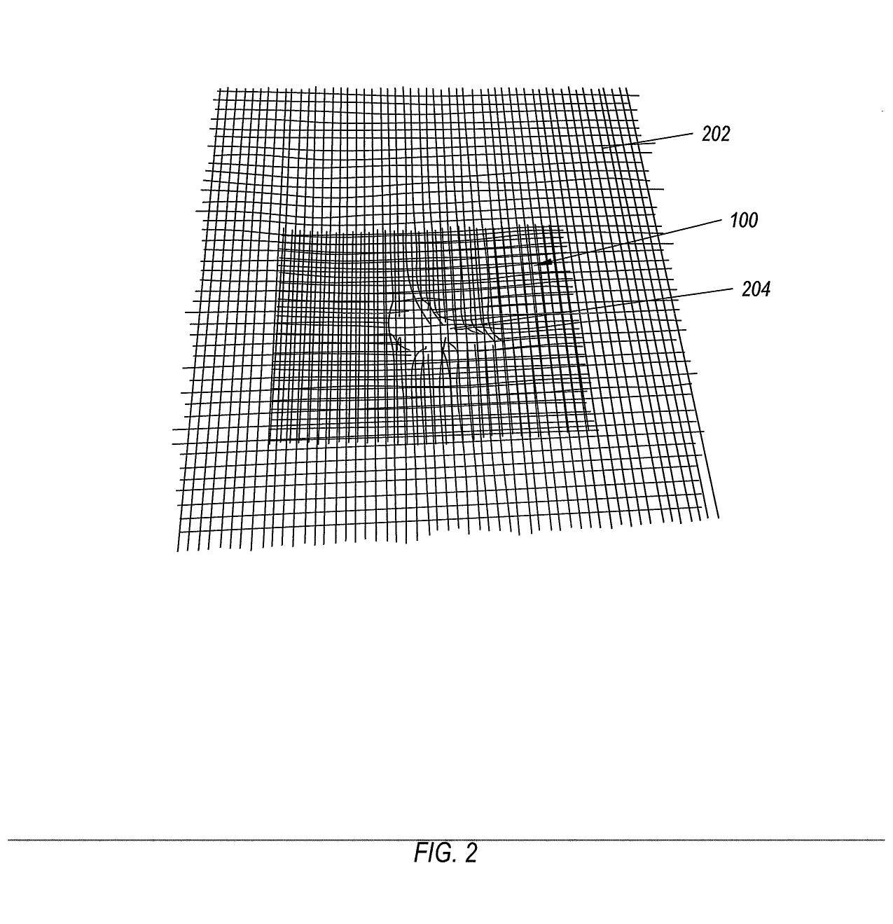

FIG. 2 illustrates an example of a screen repair using the screen repair system 100. The screen repair system 100 is secured to the existing screen 202, thus preventing the need to replace the entire screen system. That is, the screen repair system 100 covers the damage to the existing screen 202, preventing the need to replace the existing screen material.

FIG. 2 shows that the screen repair system 100 is placed over the damaged section 204 of the existing screen 202. The laminate bonds the screen mesh 102 over the damaged section 204, restoring the functionality of the existing screen 202. That is, the existing screen 202 and the screen mesh 102 in combination allow air flow but prevent unwanted entry of objects such as insects or debris.

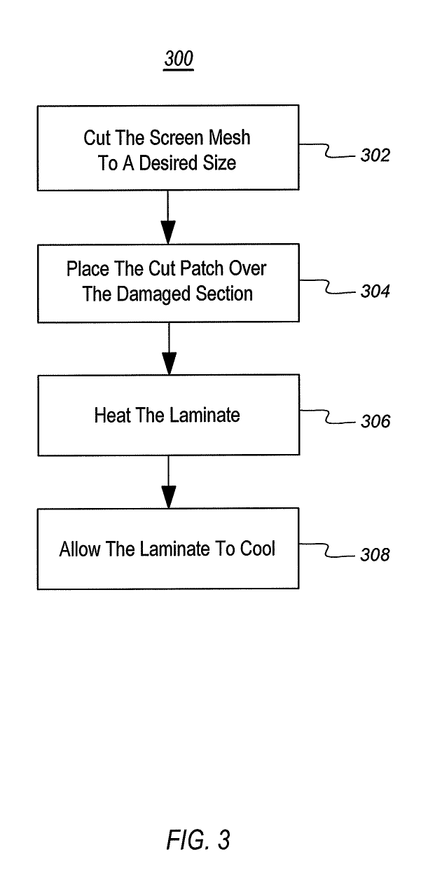

FIG. 3 is a flow chart illustrating a method 300 of repairing an existing screen using a screen repair system. In at least one implementation, the screen repair system can be a section of screen repair system, such as the screen repair system 100 of FIGS. 1-2. Therefore, the method 300 will be described, exemplarily, with reference to the screen repair system 100 of FIGS. 1-2. Nevertheless, one of skill in the art can appreciate that the method 300 can be used with a screen repair system other than the screen repair system 100 of FIGS. 1-2.

FIG. 3 shows that the method 300 can include cutting 302 the screen mesh to the desired size. The screen mesh 102 can be cut using any desired tool, such as scissors, a knife, etc. to any desired size and/or shape to customize the repair. One of skill in the art will appreciate, however, that there may need to be overlap between the screen mesh 102 and the non-damaged section to provide a sufficiently large area for bonding. For example, the screen mesh 102 can be cut such that the edges of the screen mesh 102 are all at least ½ inch from the damaged section 204.

FIG. 3 further shows that the method 300 can include placing 304 the cut patch over the damaged section 204. That is, the cut screen mesh is placed 304 such that the patch covers either a portion of or the entirety of the damaged section of the screen.

FIG. 3 also shows that the method 300 can include heating 306 the laminate. The laminate 104 can be heated using a heat gun or a hair dryer. The laminate 104 must be heated 306 beyond the melting point of the laminate 104. That is the laminate is heated 306 to a temperature where the laminate transitions to the liquid phase. One of skill in the art will appreciate that heating 306 the laminate may occur while the patch is placed 304 over the damaged section. That is, placing 304 the cut patch and heating 306 the laminate may occur simultaneously.

FIG. 3 additionally shows that the method 300 can include allowing 308 the laminate to cool. As the laminate is allowed 308 to cool it creates a bond between the screen mesh 104 and the existing screen 202. Thus, the screen mesh 102 covers the damaged section 204, producing a repair that includes the desired functionality.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

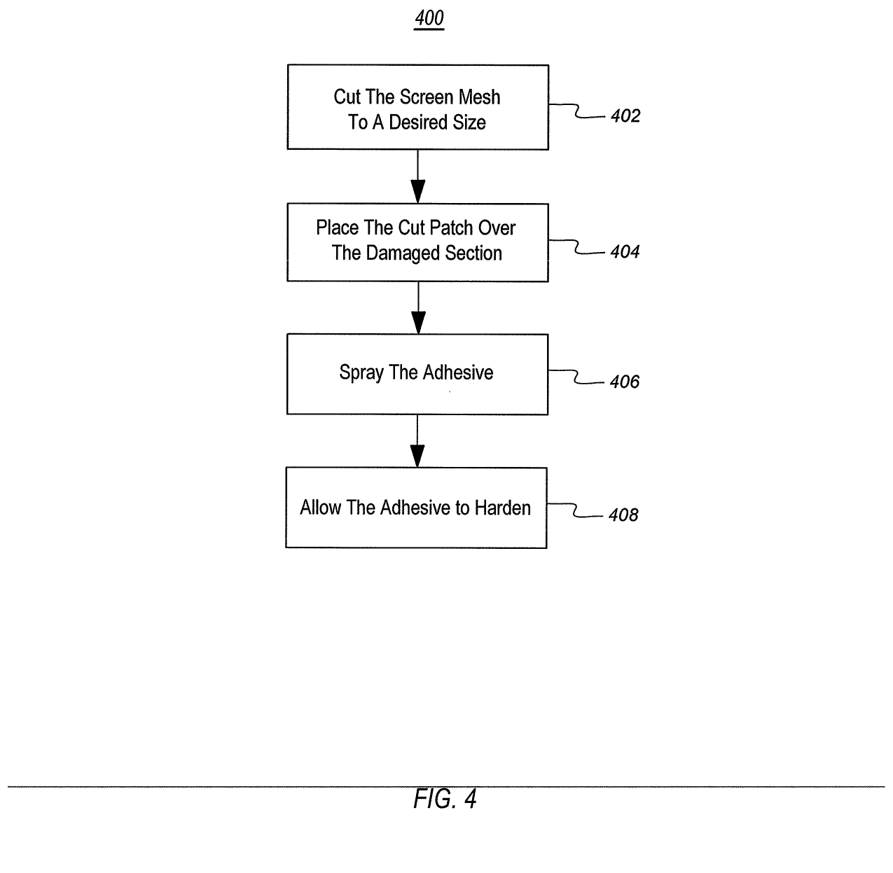

FIG. 4 is a flow chart illustrating a method 400 of repairing an existing screen using a screen repair system that utilizes a spry adhesive. In at least one implementation, the screen repair system can be a section of screen repair system, such as the screen repair system 100 of FIGS. 1-2. Therefore, the method 400 will be described, exemplarily, with reference to the screen repair system 100 of FIGS. 1-2. Nevertheless, one of skill in the art can appreciate that the method 400 can be used with a screen repair system other than the screen repair system 100 of FIGS. 1-2.

FIG. 4 shows that the method 400 can include cutting 402 the screen mesh to the desired size. The screen mesh 102 can be cut using any desired tool, such as scissors, a knife, etc. to any desired size and/or shape to customize the repair. One of skill in the art will appreciate, however, that there may need to be overlap between the screen mesh 102 and the non-damaged section to provide a sufficiently large area for bonding. For example, the screen mesh 102 can be cut such that the edges of the screen mesh 102 are all at least ½ inch from the damaged section 204.

FIG. 4 further shows that the method 400 can include placing 404 the cut patch over the damaged section 204. That is, the cut screen mesh is placed 404 such that the patch covers either a portion of or the entirety of the damaged section of the screen.

FIG. 4 also shows that the method 400 can include spraying 406 the adhesive. The adhesive tends to stick to the screen mesh of both the patch and the existing screen 202. Thus adhesive secures the patch only where screen mesh is present and allows air to continue to pass through the mesh.

FIG. 4 additionally shows that the method 400 can include allowing 408 the adhesive to harden. As the adhesive is allowed 408 to harden it creates a bond between the screen mesh 104 and the existing screen 202. Thus, the screen mesh 102 covers the damaged section 204, producing a repair that includes the desired functionality.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A screen repair system, the screen repair system comprising:
a screen mesh; and
a laminate, wherein the laminate is:
located on the screen mesh; and
configured to secure the screen mesh to an existing screen.

2. The system of claim 1, wherein the screen mesh includes aluminum stands.

3. The system of claim 1, wherein the screen mesh includes fiberglass stands.

4. The system of claim 1, wherein the screen mesh is approximately 110 grams per square meter.

5. The system of claim 1, wherein the strands of the screen mesh have a diameter of approximately 0.25 mm.

6. The system of claim 1, wherein the laminate includes EVA hot melt glue.

7. The system of claim 6, wherein the EVA hot melt glue includes between 10% and 40% vinyl acetate.

8. The system of claim 1, wherein the laminate is configured to melt between 90° C. and 100° C.

9. The system of claim 1, wherein the thickness of the laminate is approximately 0.4 mm.

10. The system of claim 1 further comprising a PVC dip coating on the screen mesh.

11. A screen repair system, the screen repair system comprising:
a screen mesh, wherein the screen mesh includes fiberglass strands;
a PVC dip coating on the screen mesh; and
a laminate, wherein the laminate:
includes EVA hot melt glue;
is configured to melt between 90° C. and 100° C.;
is located on the screen mesh; and
is configured to secure the screen mesh to an existing screen.

12. The system of claim 11, wherein the laminate is approximately 54% of the screen repair system by weight.

13. The system of claim 11, wherein the screen mesh is approximately 30% of the screen repair system by weight.

14. The system of claim 11, wherein the laminate is approximately 16% of the screen repair system by weight.

15. A method for repairing an existing screen, the method comprising:
providing a screen repair system, wherein the screen repair system includes:
a screen mesh;
a PVC dip coating on the screen mesh; and
a laminate, wherein the laminate:
includes EVA hot melt glue;
is located on the screen mesh; and
is configured to secure the screen mesh to an existing screen;
cutting the screen mesh to the desired size;
heating the laminate;
placing the cut patch over a damaged section of the existing screen; and
allowing the laminate to cool.

16. The method of claim 15, wherein the edges of the screen mesh are cut at least ½ inch from the damaged section.

17. The method of claim 15, wherein the laminate is heated using a hair dryer.

18. The method of claim 15, wherein heating the laminate includes increasing the temperature beyond 90° C.

19. The method of claim 15, wherein the laminate is approximately 54% of the screen repair system by weight.

20. The method of claim 15, wherein the screen mesh is approximately 30% of the screen repair system by weight.
